(19) United States
(12) Patent Application Publication
(10) Pub. No.: US 2004/0008948 A1
(43) Pub. Date: Jan. 15, 2004

(54) Oval resonator device

(76) Inventors: Mee-Koy Chin, Wilmette, IL (US); Seng-Tiong Ho, Wheeling, IL (US)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/445,514

(22) Filed: May 27, 2003

Related U.S. Application Data
(63) Continuation of application No. 09/574,834, filed on May 19, 2000, now abandoned.
(60) Provisional application No. 60/135,378, filed on May 21, 1999.

(51) Int. Cl. G02B 6/26

(52) U.S. Cl. 385/50

(57) ABSTRACT

An oval resonator device is provided which includes an oval resonator having straight portions for coupling signals from external sources. The straight portions of the oval resonator minimize phase mismatch in a coupled signal. The oval resonator device can be used in various devices including channel-dropping filters, switches, tunables filters, phase modulators, and 1×N multiplexers/demultiplexers.

### CROSS-REFERENCE TO RELATED APPLICATIONS

This application claims priority to Provisional Patent Application Serial No. 60/135,378, filed on May 21, 1999.

### STATEMENT REGARDING FEDERALLY SPONSORED RESEARCH AND DEVELOPMENT

The present invention was developed under Grant Number: ECS-9502475 provided by the National Science Foundation and Grant Number: DAAH04-95-1-1043 provided by the Advanced Research Project Agency of the Department of Defense. The Government may have certain rights in the invention.

### FIELD OF THE INVENTION

This invention relates to nanophotonic devices, and, more particularly, to optical resonator devices.

### BACKGROUND OF INVENTION

Optical elliptical resonators, including circular resonators, are known in the prior art. For example, U.S. Pat. No. 5,926,496 entitled “SEMICONDUCTOR MICRO-RESONATOR DEVICE” which issued on Jul. 20, 1999 to the inventors herein, discloses a micro-resonator device having a circular disk shape, an annular ring shape, or a distorted disk shape or ring that partially follows the outline of a circular diameter. Although this device is very effective in causing light transference of a light signal on resonance with the resonator, the use of an elliptical resonator causes phase mismatch with the light travelling in an adjoining input/output waveguide. In particular, reference is made to FIG. 1, which was taken from FIG. 8 of U.S. Pat. No. 5,926,496. As shown therein, light propagating in the waveguide 1050 that is on resonance with the resonator 1052 is coupled over an optical path length Δs₂ of the waveguide 1050 with an optical path length Δs₁ of the resonator 1052. Over the arc angle θ, the coupled light may go out of phase due to the difference in optical path length (Δs₂-Δs₁). U.S. Pat. No. 5,926,496 is concerned with limiting the phase mismatch to less than π/2. To achieve this objective, it is indicated that the coupling length should not exceed approximately 1/10^{th} the resonator circumference. As is readily appreciated, the same phase mismatch problem is present in non-circular, elliptical resonator devices, and where straight waveguides are in an elliptical resonator device.

Additionally, the gap size (the distance between the resonator and the input/output waveguide) is generally very small with elliptical resonator devices. The small size ensures that acceptable coupling efficiency (the percentage of optical power coupled from the input to the resonator and from the resonator to the output) is achieved. For example, as shown in FIG. 1A, which was taken from U.S. Pat. No. 5,926,496, an exemplary gap width gw of 0.1 μm is disclosed between the resonator 1052 and the straight waveguide 1050B with an effective coupling length of 1.0 μm. The coupling length is relatively short due to the short interaction distance between the resonator and the coupled straight waveguide. As is readily appreciated, the interaction distance is kept to a minimum with a circular resonator being used.

Thus, there exists a need in the art for an optical device that overcomes the above-described shortcomings of the prior art.

### SUMMARY OF THE INVENTION

The aforementioned objects are met by an optical resonator device which includes an oval resonator, an input waveguide, and an output waveguide. The oval resonator operates to transfer signals from the input waveguide to the output waveguide. As used herein, the term “oval” refers to a continuous form having two arcuate ends and two straight sides extending therebetween. It is preferred that the straight sides of the oval resonator be generally parallel.

The input waveguide and the output waveguide, each respectively have an input port, an output port, and portions that are respectively spaced from the straight sides of the oval resonator to define gaps therebetween. As described below the device is usable in various applications.

The oval shape of the resonator of the subject invention overcomes the phase mismatch problem found in the prior art. In particular the input and output waveguides preferably have portions thereof aligned substantially parallel to the straight sides of the resonator so as to define elongated, constant-width input and output gaps between the waveguides and the resonator. The elongation and constant width of the respective gaps define longer coupling lengths across which signals may couple. (The coupling length is the length of optical path along which coupling occurs.) In prior art elliptical resonator devices, such as the circular resonator device discussed above, the coupling length is difficult to determine due to the differences in optical path lengths. With the straight sides of the oval resonator, the same length optical paths are defined in the input and the output waveguides as in the resonator. As a result, not only is the coupling length more clearly defined, but also the efficacy of the resonator device is increased.

The oval resonator device preferably is formed within the following dimensional parameters: gaps between the resonator and the input waveguide and the output waveguide, respectively, have a width of less than 0.5 μm; a width of less than 1.0 μm is preferably defined in the resonator, the input waveguide, and the output waveguide; coupling lengths of less than 10.0 μm are preferably utilized; and, the ratio of the index of refraction of the core of the waveguides and the oval resonator to the index of refraction of a medium in the gaps is preferably greater than 1.5.

With the specified parameters, the oval resonator device preferably operates at a coupling factor of approximately 0.01-0.1. The coupling factor is a decimal representation of the percentage of optical power of a signal that is transferred between the resonator and the adjacent waveguides. The portion of the signal in the input waveguide whose wavelength is on resonance with the resonator passes through the resonator to the output waveguide, whereas portions of the signal in the input waveguide which are off resonance with the resonator by-pass the resonator and exit from the input waveguide. Thus, the oval resonator serves as a wavelength filter that separates out the resonance wavelengths from the remainder of the signal. The resonance condition is satisfied when the round-trip length of the resonator is equal to an integer multiple of the optical wavelength in the waveguide medium.

The coupling factor is dependent on several factors including the gap widths, the coupling lengths, the waveguide widths, the indices of refraction, the polarization of the light being transferred, and the wavelength of the light. With the subject invention, the gap widths can be made larger than that disclosed in the prior art circular resonator device, with longer coupling lengths being used to achieve the same coupling factor as the circular resonator device. The increase in gap widths causes a drop in coupling factor, wherein, an increase in coupling length causes an increase in coupling factor. With the subject invention, by increasing the coupling length, an increase in coupling factor is achieved that is at least commensurate with the drop in the coupling factor caused by the increase in the gap width. The net effect is to produce a resonator device that is easier to manufacture, because of the more generous gap width than that in the prior art, without any sacrifice in performance. Additionally, the coupling lengths can be easily changed in the resonator device, since the length of the side portions can be increased as needed to achieve the desired coupling factor, without requiring the arcuate ends to be altered. In this manner, oval resonators with generally the same overall width (as measured between the straight portions) can operate with different coupling factors. In contrast, the elliptical resonators of the prior art, including circular resonators, require changes in curvature, gap widths, etc., to achieve changes in coupling factor—which is difficult to realize.

The oval resonator is preferably defined by a single, uninterrupted waveguide element that is formed to define the oval shape. It is preferred that symmetry be achieved in the oval resonator device. Specifically, the input waveguide, the output waveguide, and the waveguide element of the resonator are preferably identically or substantially identically formed (materials; dimensioning) to enable efficient transfer of the light signal. The waveguides and waveguide element can be either photonic wire waveguides, such as that disclosed in U.S. Pat. No. 5,878,070, or photonic well waveguides, such as that disclosed in U.S. Pat. No. 5,790,583. It is preferred that photonic well waveguides be used with the subject invention. If photonic wire waveguides are used, the same height in the core of the waveguides and the waveguide elements, in addition to the same width, is preferably used to enable efficient transfer of the light signal. Additionally, it is preferred that the height and width dimensions of the core be equal. U.S. Pat. No. Pat. Nos. 5,790,583 and 5,818,070 are incorporated by reference herein in their respective entireties.

The oval resonator device can be used to form various devices, including, but not limited to, channel-dropping filters, switches, tunable filters, phase modulators, and 1×N multiplexers/demultiplexers. Additionally, multiple oval resonators can be arranged in an array, either in parallel or in series, to manipulate the frequency spectrum of the output signal.

The invention accordingly comprises the features of construction, combination of elements, and arrangement of parts which will be exemplified in the disclosure herein, and the scope of the invention will be indicated in the claims.

### BRIEF DESCRIPTION OF THE DRAWINGS

In the drawing figures, which are not to scale, and which are merely illustrative, and wherein like reference numerals depict like elements throughout the several views:

FIG. 1 is a top plan view of a prior art circular resonator device;

FIG. 1A is a top plan view of a prior art circular resonator device with a straight waveguide;

FIG. 2 is a top plan view of an oval resonator device formed in accordance with the subject invention;

FIG. 3 is a partial cross-sectional view taken along line 3-3 of FIG. 2;

FIG. 4 is a top plan view of a channel-dropping filter device formed in accordance with the subject invention;

FIG. 5 is a graph indicating the output of the input waveguide (reflection) of the channel-dropping filter device shown in FIG. 4;

FIG. 6 is a graph indicating the output of the output waveguide (transmission) of the channel-dropping filter device shown in FIG. 4;

FIG. 7 is a top plan view of a 1×4 multiplexer/demultiplexer device formed in accordance with the subject invention;

FIG. 8 is a top plan view of a device having a cascaded array of oval resonators arranged in parallel;

FIG. 9 is a top plan view of a device having a cascaded array of oval resonators arranged in series; and,

FIG. 10 is a top plan of a phase modulator device formed in accordance with the subject invention.

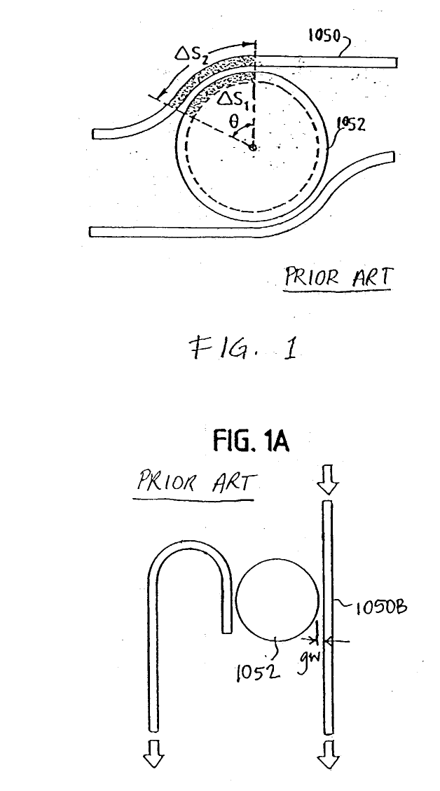

### DETAILED DESCRIPTION OF THE PREFERRED EMBODIMENTS

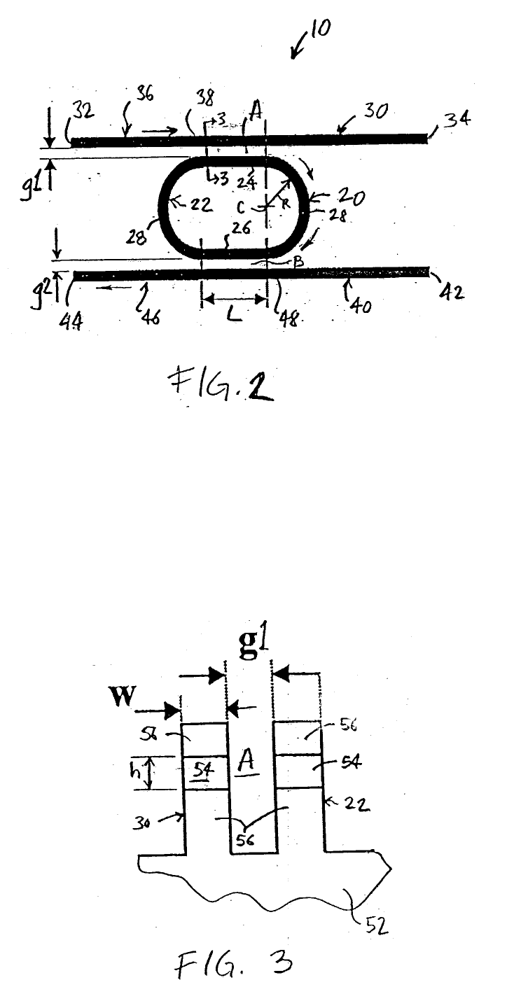

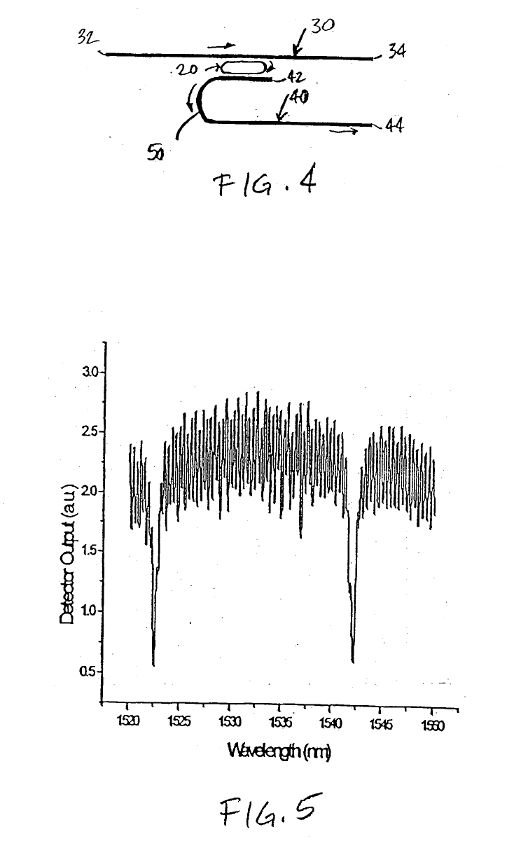

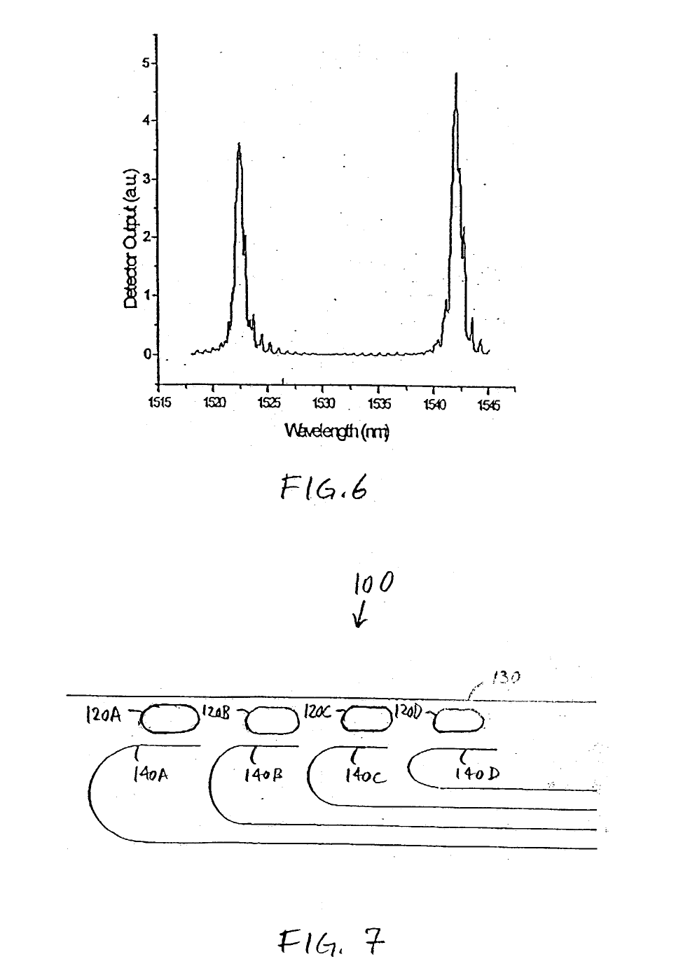

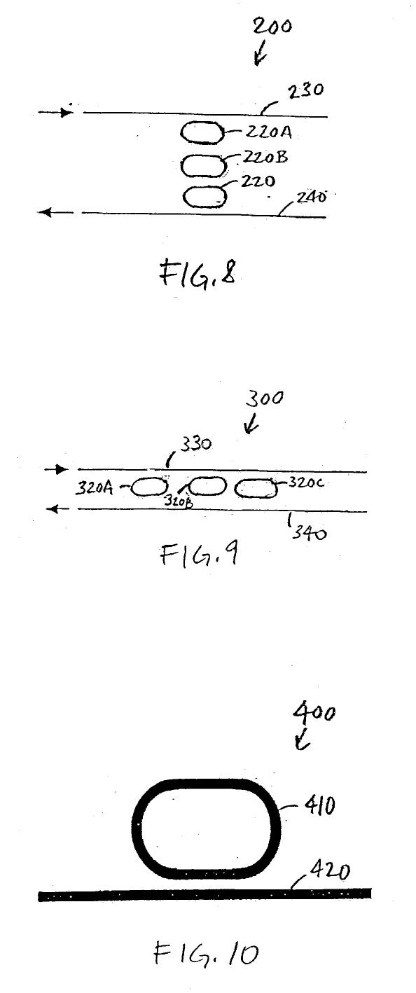

Referring to FIG. 2, an oval resonator device is depicted and generally designated with the reference numeral 10. The device 10 includes an oval resonator 20, an input waveguide 30, and an output waveguide 40.

The oval resonator 20 is preferably defined by a single, uninterrupted waveguide element 22. The element 22 has two generally straight portions: a first straight portion 24 and a second straight portion 26. Also, two arcuate ends 28 extend between and connect the straight portions 24 and 26. It is preferred that the oval resonator 20 have a symmetrical appearance with the straight portions 24 and 26 being substantially parallel and having generally the same length L. Also, the arcuate ends 28 are preferably formed with the same degree of curvature. For example, the arcuate ends 28 may respectively be each defined about a center C and formed by a radius R. The center C is preferably aligned with ends of the straight portions 24, 26 such that the arcuate ends 28 are each semi-circular in shape.

The input waveguide 30 has an input port 32, an output port 34, and a signal transmitting portion 36 extending therebetween. A length 38 of the signal transmitting portion 36 is located in proximity to the first straight portion 24 so as to define a gap A therebetween having a width g1. It is preferred that the length 38 be substantially parallel to the straight portion 24, so as to define a substantially constant gap width g1 along the complete length L of the first straight portion 24.

The output waveguide 40 has an input port 42, an output port 44, and a signal transmitting portion 46 extending therebetween. A length 48 of the signal transmitting portion 46 is located in proximity to the second straight portion 26 so as to define a gap B therebetween having a width g2. It is preferred that the length 48 be substantially parallel to the second straight portion 26, so as to define a substantially constant gap width g2 along the complete length of the second straight portion 26. It is also preferred that the width g1 be equal to the width g2.

With the oval resonator 20 being tuned to a predetermined resonance frequency, a portion of a signal travelling from the input port 32 towards the output port 34 of the input waveguide 30 that is on resonance with the oval resonator 20, interferes constructively, resonates and passes through the oval 20 resonator to the output waveguide 40, whereas portions of the signal that are off resonance with the oval resonator 20 continue to the output port 34 and are emitted as a reflection signal. The resonated signal passes to the output waveguide 40. Because of the shape of the oval resonator 20, the resonated signal will pass into the output waveguide 40 in an opposite direction from the signal travelling in the input waveguide 30, as indicated by the arrows. Specifically, the resonated signal will pass into the output waveguide 40 travelling in a direction towards the output port 44 and be emitted therefrom as a transmission signal. To direct the resonated signal in the output waveguide 40 in the same direction as the input waveguide 20, the output waveguide 40 can be curved as shown in FIG. 4, to have an arcuate bend 50, preferably of 180°. It is to be understood that the references to “input” and “output” herein are only for convenience; the oval resonator device 10 can be used with a signal passing through the waveguides in any direction consistent with the disclosure herein.

It is preferred that symmetry be achieved in the oval resonator device 10. Specifically, the input waveguide 20, the output waveguide 30, and the waveguide element 22 of the oval resonator 20 are preferably identically or substantially identically formed (materials; dimensioning) to enable efficient transfer of the light signal. The waveguides 20, 30 and the waveguide element 22 can be either photonic wire waveguides or photonic well waveguides that extend from a substrate 52. Etching techniques known in the prior art can be used to form the waveguides 20, 30 and the waveguide element 22. It is preferred that photonic well waveguides be used with the subject invention.

FIG. 3 depicts a representative cross-section of the input waveguide 30, along with the waveguide element 22. The output waveguide 40 preferably has the same cross-section that is shown. As shown representatively, a core 54 is provided surrounded by layers of cladding 56. The core 54 is the active light carrying medium, and the core 54 of each of the respective waveguides 30, 40 and the waveguide element 22 is preferably formed with a width w. If photonic wire waveguides are used, the same height h is preferably used with each of the cores 54, in addition to the same width w, to enable efficient transfer of the light signal. Additionally, it is preferred that the height h and width w dimensions of the cores 54 be equal.

FIGS. 5 and 6 depict performance characteristics of the oval resonator device 10 as shown in FIG. 4. FIG. 5 is a graph that shows the intensity of the reflection signal emitted from the output port 34 of the input waveguide 30, whereas, FIG. 6 shows the intensity of the transmission signal emitted from the output port 44 of the output waveguide 40. The lowest values on the graph in FIG. 5 correspond to approximately 1522.5 nm and 1542.5 nm wavelengths, respectively. As a corollary, the highest values on the graph in FIG. 6 also correspond to 1522.5 nm and 1542.5 nm, respectively. The graphs represent a spectrum resonating about 1542.5 nm with portions of the signal at this wavelength being passed from the input waveguide 30 to the output waveguide 40. The portions of the signal that do not resonate by-pass the oval resonator 20 and are emitted from the output port 34 of the input waveguide 30 as the transmission signal. The wavelength at which the oval resonator 20 is set to resonate is adjustable using techniques known to those skilled in the art, such as by applying different electric voltages to the resonator.

Design Parameters

It is preferred that the oval resonator device 10 be formed within the ranges of certain parameters. First, it is preferred that the widths g1 and g2 be less than 0.5 μm. More specifically, it is preferred that the widths g1 and g2 be selected so as to conform with the following relationship,

$$gap width ( g1 or g2 ) \leq \frac{λ}{\sqrt{{n}_{wg}^{2} - {n}_{g}^{2}}} , \qquad \text{Eq. (1)}$$

where,

X is the wavelength of the signal in vacuum;

n_{wg} is the index of refraction inside the core of the waveguide; and,

n_{g} is the index of refraction of a medium disposed in the respective gap.

Second, it is preferred that the waveguides 30, 40 and the waveguide element 22 be each formed with a width w that is less than 0.5 μm. The preferred width w enables the waveguides 30, 40 and the waveguide element 22 to fulfill a single-mode requirement (i.e., the respective waveguide/waveguide element supports only one fundamental transverse electric (TE) and one fundamental transverse magnetic (TM) mode.

Third, it is preferred that the length L of both the straight portions 24 and 26 be less than 10 μm. The length L is limited by the round-trip length of the oval resonator 20, as described below.

Fourth, it is preferred that the ratio of the index of refraction inside the core of the waveguide n_{wg} to the index of refraction of the medium inside the respective gap n_{g} be greater than 1.5. Stated algebraically,

n_{wg}/n_{g}>1.5. Eq. (2)

Fifth, round-trip loss must be taken into consideration. With the specified parameters, the oval resonator device 10 preferably operates at a coupling factor of approximately 0.01-0.1. The coupling factor is a function of the gap widths (g1, g2), the coupling length (L), the indices of refraction (n_{wg}, n_{g}), the polarization of the light being transferred, and the wavelengths of the light (λ). Within the preferred ranges, the gap widths g1, g2 can be made larger than that disclosed with the elliptical and circular resonator devices of the prior art. To compensate for loss in coupling factor due to increases in the gap widths, the coupling lengths L are increased so as to achieve at least the same coupling factor as the circular resonator device.

The oval resonator device 10, as with all closed loop devices, is susceptible to “round trip loss” with a certain portion of the signal being lost upon traversing the oval resonator 20. It is preferred that the coupling factor of the oval resonator device 10 be greater than the round trip loss, and more preferably, several times greater than the round trip loss. In an exemplary embodiment, with a round trip loss of 0.03 (i.e., 3%), the coupling factor may be 0.13 (i.e., 13%), i.e., more than four times greater than the round trip loss. In this manner, the detrimental effects of round trip loss can be kept to a minimum. Admittedly, a coupling factor of 0.13 exceeds the preferred range of 0.01-0.1. The range of 0.01-0.1 is more applicable where minimal round trip losses are present.

A sixth design parameter which needs to be considered in the design of the oval resonator device 10 is the resonance wavelengths and free spectral range (FSR). Resonance wavelengths occur periodically with uniform spacing therebetween. The resonance wavelengths (λm) are given by

mλₘ=n_{eff}L, Eq. (3)

where m is an integer.

The term “m” is known as the order of the resonance, “n_{eff}” is the effective refractive index of the resonator, and “n_{eff}L” is the optical length of the resonator. The spacing between successive resonances is known as the free spectral range (FSR). Hence, it can be seen that the smaller the resonator is, the larger the FSR will be.

Advantageously, the oval resonator device 10 can be used in various devices and configurations. The resonance wavelength of the resonator, being determined by the optical length of the resonator, can be tuned or modulated by modulating the effective index of the resonator. This can be achieved using the electro-optic effect in the semiconductor material comprising the waveguide, whereby an electric field (or voltage) is applied directly to the resonator to modify the refractive index of the material therein. For example, FIG. 4 depicts a channel-dropping filter or a wavelength switch. As a channel-dropping filter, the device simply drops a particular wavelength (or channel) from the input signal that corresponds to the resonance wavelength of the resonator. As a wavelength switch, the device is operated as a tunable filter that is being tuned between being on and being off resonance for the particular wavelength to be switched.

Additionally, the device 10 can be used in a 1×N multiplexer/demultiplexer device, such as the 1×4 multiplexer/demultiplexer device 100 shown in FIG. 7. Herein, four oval resonators 120A, 120B, 120C, and 120D are arranged along a common input waveguide 130, although any number of the oval resonators may be used in conjunction with the device. The oval resonators 120A-D are each tuned to resonate at a different wavelength so that different portions of the signal travelling through the input waveguide 130 are caused to be resonated by the various oval resonators 120A-120D and passed along to the respective output waveguides 140A-D, thereby demultiplexing the signal. The device 100 can also be used in “reverse” to multiplex signals travelling through the output waveguides 140A-D and cause a composite signal to be generated in the input waveguide 130.

Furthermore, the device 10 can be used in a cascaded array, such as the arrays shown in FIGS. 8 and 9 to obtain a desired frequency spectrum. In many applications it is desired that the spectral characteristics of the filter exhibit a flat top shape at the peak of a response, so as to accommodate drift in the wavelength of the source caused by temperature or source wavelength fluctuations, such as shown in FIG. 6. One realization of this desired result is depicted in FIG. 8 by a parallel array of identical resonators coupled to each other. A filter with arbitrary characteristics can be realized by judiciously choosing the coupling coefficients between individual resonators and between the resonators and the parallel straight waveguides. In the simplest case, one may assume these coupling coefficients to be identical. In this case, the overall behavior of the filter is such that the resonance wavelengths of the individual resonators become split into a multitude of resonances equal to the number of resonators. The spacing between the resonances is determined by the strength of the coupling coefficient between the resonators (the stronger the coupling, the larger the separation between these resonances). Therefore, by judiciously choosing the coupling coefficient, one can advantageously shift the resonances close enough so that they essentially merge together to form a single resonance with a flat top.

FIG. 8 specifically depicts a parallel array 200 which includes a plurality of oval resonators 220A, 220B, and 220C coupled to one another between input waveguide 230 and output waveguide 240. Three oval resonators 220A-C are shown in FIG. 8 by way of non-limiting example, and any number of resonators can be used. The oval resonator 220A is coupled to the input waveguide 230 and to the oval resonator 220B, whereas, the oval resonator 220C is coupled to the output waveguide 240 and to the oval resonator 220B. As such, this arrangement results in a frequency response in the output signal transmitted to the output waveguide 240 that is centered about a single resonance wavelength.

Another desirable characteristic of a filter response is that the roll-off on the sides of the response be sufficiently rapid so as to minimize the crosstalk between one channel and all the other channels (as depicted in FIG. 6). A single resonator is effectively a first-order Fabry-Perot filter with a Lorentzian response that has a relatively slow roll-off. To improve the roll-off, one can essentially cascade multiple identical resonators in series so as to realize a higher-order filter that by definition has a faster roll-off. This realization is depicted in FIG. 9. It is essential that the resonators be lined up exactly in their resonance frequencies, otherwise the output signal will have a broader frequency spectrum. FIG. 9 depicts a series array 300 which includes a plurality of oval resonators 320A, 320B and 320C which are each coupled to an input waveguide 330 and an output waveguide 340, but not coupled to each other. Again, any number of the oval resonators can be used. As a result, an output signal is generated in the output waveguide 340 that has a broader frequency spectrum with “steeper” side slope characteristics than that generated by a single oval resonator formed in accordance with the subject invention.

As yet a further application, the oval resonator of the subject invention can be used with a single waveguide as shown in FIG. 10. Here, an all-pass filter 400 is shown, which may be used as a phase modulator. The all-pass filter 400 includes an oval resonator 410 disposed adjacent to an input waveguide 420. The oval resonator 410 “reflects” light of all frequencies passing through the input waveguide 420 with a phase response that depends on the coupling strength between the oval resonator 410 and the input waveguide 420. Thus, light passing through such a filter undergoes no change in amplitude but a change in phase. This phase shift can be modulated, again using the electro-optic effect applied to the resonator. This phase modulator can be incorporated into a Mach-Zehnder interferometer to realize amplitude modulation. The advantage of this phase modulator is that the required modulation voltage for a given phase shift (say, π) can be very small because the resonant effect of the resonator effectively increases the optical length of the device. Alternatively, for a given modulation voltage, the phase modulator can be much smaller and yet is capable of achieving a π-phase shift. By applying and varying a voltage to the oval resonator 410, the phase of the light can be altered. The all-pass filter 400 of the subject invention is considerably smaller than phase modulators formed in the prior art.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

What is claimed is:

1. A resonator device comprising,
an oval resonator capable of resonating light of a predetermined wavelength, said oval resonator having two arcuate ends and generally straight first and second side portions extending therebetween;
an input waveguide for propagating light therein, said input waveguide having an input port and an output port, a portion of said input waveguide being disposed adjacent to said first side portion of said oval resonator; and,
an output waveguide for propagating light therein, said output waveguide having an output port, a portion of said output waveguide being disposed adjacent to said second side portion of said oval resonator, wherein light propagating in said input waveguide with a wavelength off resonance with said oval resonator is output from said output port of said input waveguide and light propagating in said input waveguide with a wavelength on resonance with said oval resonator is coupled to said oval resonator and from said oval resonator to said output waveguide for output from the output port of said output waveguide.

2. A resonator device as in claim 1, wherein said input waveguide is separated from said first side portion by a first gap, said first gap being less than 0.5 μm.

3. A resonator device as in claim 2, wherein said output waveguide is separated from said second side portion by a second gap, said second gap being less than 0.5 μm.

4. A resonator device as in claim 1, wherein said first side portion has a length of less than 10.0 μm.

5. A resonator device as in claim 4, wherein said second side portion has a length of less than 10.0 μm.

6. A resonator device as in claim 1, wherein said input waveguide defines a width in said portion disposed adjacent to said first side portion of said oval resonator, said width being measured transversely relative to the longitudinal axis of said input waveguide, said width being less than 1.0 μm.

7. A resonator device as in claim 6, wherein said output waveguide defines a width in said portion disposed adjacent to said second side portion of said oval resonator, said width being measured transversely relative to the longitudinal axis of said output waveguide, said width being less than 1.0 μm.

8. A resonator device as in claim 1, wherein said input waveguide is formed with a first core through which the light propagates, said first core having a first inner index of refraction, and wherein said input waveguide is separated from said first side portion by a first gap, a first medium being disposed in said first gap, said first medium having a first outer index of refraction, the ratio of said first inner index of refraction to said first outer index of refraction being greater than 1.5.

9. A resonator device as in claim 8, wherein said output waveguide is formed with a second core through which the light propagates, said second core having a second inner index of refraction, and wherein said output waveguide is separated from said second side portion by a second gap, a second medium being disposed in said second gap, said second medium having a second outer index of refraction, the ratio of said second inner index of refraction to said second outer index of refraction being greater than 1.5.

10. A resonator device as in claim 1, wherein said first side portion and said second side portion are substantially parallel.

11. A resonator device as in claim 1, wherein said portion of said first waveguide disposed adjacent to said first side portion of said oval resonator is substantially parallel thereto.

12. A resonator device as in claim 11, wherein said portion of said second waveguide disposed adjacent to said second side portion of said oval resonator is substantially parallel thereto.

13. A resonator device as in claim 1, wherein said oval resonator is formed from a single, uninterrupted waveguide element.

14. A resonator device as in claim 13, wherein said waveguide element has a width that is less than 1.0 μm.

15. A resonator device as in claim 1, wherein the coupling factor between said input waveguide and said oval resonator is in the range of 0.01 to 0.1.

16. A resonator device as in claim 1, wherein the coupling factor between said input waveguide and said oval resonator is several times greater than the round trip loss experienced in said oval resonator.

17. A resonator device as in claim 1, wherein a plurality of oval resonators are disposed between said input and output waveguides.

18. A resonator device as in claim 17, wherein each said oval resonator is coupled to at least one other oval resonator.

19. A resonator device as in claim 17, wherein each said oval resonator is coupled to both said input waveguide and said output waveguide.

20. An oval resonator for resonating light of a predetermined wavelength, said oval resonator comprising two arcuate ends and generally straight first and second side portions extending between said arcuate ends.

21. An oval resonator as in claim 20, wherein said first and second side portions are substantially parallel.

22. An oval resonator as in claim 20, wherein said arcuate ends are each generally semi-circular in shape.

23. An oval resonator as in claim 20, wherein said first side portion has a length of less than 10.0 μm.

24. An oval resonator as in claim 23, wherein said second side portion has a length of less than 10.0 μm.

25. An oval resonator as in claim 20, wherein said oval resonator is formed from a single, uninterrupted waveguide element.

26. An oval resonator as in claim 25, wherein said waveguide element has a width that is less than 1.0 μm.

27. A resonator device comprising,
an oval resonator capable of resonating light of a predetermined wavelength, said oval resonator having two arcuate ends and generally straight first and second side portions extending therebetween; and,
an input waveguide for propagating light therein, said input waveguide having an input port and an output port, a portion of said input waveguide being disposed adjacent to said first side portion of said oval resonator.

28. A resonator device as in claim 27, wherein the coupling factor between said input waveguide and said oval resonator is in the range of 0.01 to 0.1.

29. A resonator device as in claim 27, wherein the coupling factor between said input waveguide and said oval resonator is greater than the round trip loss experienced in said oval resonator.
